(19) United States
(12) Patent Application Publication
(10) Pub. No.: US 2003/0080840 A1
(43) Pub. Date: May 1, 2003

(54) High-frequency relay having a conductive and grounding base covering at least a bottom surface of a body

(75) Inventors: Akio Nakamura, Shinagawa (JP); Yoshinori Kurata, Shinagawa (JP); Hirofumi Saso, Shinagawa (JP)

Correspondence Address: STAAS & HALSEY LLP, 700 11TH STREET, NW, SUITE 500, WASHINGTON, DC, 20001, US

(73) Assignee: FUJITSU COMPONENT LIMITED, Tokyo (JP)

(21) Appl. No.: 10/151,969

(22) Filed: May 22, 2002

(30) Foreign Application Priority Data
Oct. 25, 2001 (JP) 2001-328209

(51) Int. Cl. H01H 51/22

(52) U.S. Cl. 335/128

(57) ABSTRACT

This high-frequency relay comprises a body containing a contact unit having contact states switched according as an energization to a coil, and a base covering at least a bottom surface of the body. The contact unit is connected with at least one contact terminal. The contact terminal is protruded from the bottom surface of the body. The base has a grounding function and includes a conductive layer.

### BACKGROUND OF THE INVENTION

1. Field of the Invention

The present invention generally relates to a high-frequency relay, and more particularly, to a high-frequency relay switching a high-frequency signal.

2. Description of the Related Art

FIG. 1A and FIG. 1B illustrate an example of a high-frequency relay.

A high-frequency relay 1a comprises an electromagnet unit 2 and a contact unit 3.

The electromagnet unit 2 comprises an iron core 2a, a coil 2b wound around the iron core 2a, and a coil terminal 2c connected to the coil 2b. The coil terminal 2c hangs down so as to be connected to a substrate not shown in the figure.

The contact unit 3 comprises a moving contact unit 4, a fixed make contact unit 5 and a fixed break contact unit 6. The fixed make contact unit 5 and the fixed break contact unit 6 are provided at positions opposite both ends of the moving contact unit 4.

The moving contact unit 4 includes an armature 4b provided opposite the electromagnet unit 2. A permanent magnet 4a is mounted to the armature 4b. A moving spring 4c is arranged unitarily with the armature 4b. A moving make contact 4d and a moving break contact 4e are provided at both ends of the moving contact unit 4. The moving contact unit 4 also includes a common terminal 4f hanging down so as to be connected to a substrate not shown in the figure.

The fixed make contact unit 5 comprises a fixed make contact 5a arranged opposite the moving make contact 4d, and a make terminal 5b hanging down so as to be connected to a substrate not shown in the figure.

The fixed break contact unit 6 comprises a fixed break contact 6a arranged opposite the moving break contact 4e, and a break terminal 6b hanging down so as to be connected to a substrate not shown in the figure.

Besides, the relay has a structure in which a contact drive card is provided by bridging and holding the armature 4b and the moving spring 4c.

With the relay 1a in use, the moving spring 4c moves according as an energization to the coil 2b so as to switch a make state in which the moving make contact 4d contacts the fixed make contact 5a and a break state in which the moving break contact 4e contacts the fixed break contact 6a. This relay may be referred to as a one-point break one-point make structure type.

With such a high-frequency relay as above that switches a high-frequency signal, an isolation characteristic is the most important among various characteristics required for the signal switching capability.

The isolation characteristic represents a leakage of a signal between a moving contact and a fixed contact (hereinbelow simply referred to as contacts) in a state where the contacts are broken. As a frequency of the signal becomes higher, the leakage increases. The isolation is defined by the following expression. As a value obtained by this expression becomes larger, the isolation exhibits a better characteristic.

Isolation=−10log(Pout/Pin) (unit: dB)

Pout: output power

Pin: input power

In order to increase the isolation characteristic, it is necessary to reduce a capacitance between the broken contacts.

Specific methods for reducing the capacitance between the broken contacts include enlarging a clearance between the contacts, and decreasing opposing areas between the contacts.

However, in the example of the high-frequency relay 1a of the one-point break one-point make structure shown in FIG. 1A and FIG. 1B, there is provided a magnetic circuit component which is a floating conductor, such as the iron core 2a or the permanent magnet 4a, in the vicinity of which the contacts 4d and 5a are arranged. Therefore, a leakage of a signal is large between the magnetic circuit component and each of the contacts 4d and 5a, between the magnetic circuit component and each of the terminals 4f and 5b connected to the contacts 4d and 5a, respectively, and between the terminals 4f and 5b. Therefore, the above-mentioned methods, such as enlarging a clearance between the contacts 4d and 5a, are not necessarily effective. In addition, to extremely enlarge the clearance between the contacts 4d and 5a makes an obstacle hindering miniaturization needs for the relay.

There is a method for solving the above-described problems of the relay 1a shown in FIG. 1A and FIG. 1B. In a relay 1b of a two-point break two-point make structure shown in FIG. 2, this method reduces a stray capacitance by grounding a moving make spring 7c via ground terminals 7d upon breaking the contacts. In FIG. 2, reference mark 7a indicates a moving break spring, and reference mark 7b indicates common fixed contacts. In addition, there are relays 1c and 1d shown in FIG. 3 and FIG. 4, respectively, in which grounded shield plates 7f are provided at peripheries of the contact unit. In FIG. 3 and FIG. 4, reference mark 7e indicates a card, and reference mark 7g indicates a resinous base. In these examples, however, the relay 1c shown in FIG. 3 has a structure in which the contact unit and the magnetic circuit are separated; this hinders miniaturization of the relay. Also, as in the relay 1d shown in FIG. 4, the grounded shield plates 7f make a complicated structure; thus, the components cannot be easily manufactured and mounted. It is noted here that, in FIG. 2 to FIG. 4 and other figures illustrating relays, the same elements are basically referenced by the same reference marks, and will not be described in detail.

In addition, for the purpose of further improving the isolation characteristic, there are a relay 1e as shown in FIG. 5A to FIG. 5C and a relay if as shown in FIG. 6A to FIG. 6C. In the relay 1e shown in FIG. 5A to FIG. 5C, a metal plating 7h is provided on a terminal-outlet surface 8a located at a bottom part of a resinous cover 8 so that the metal plating 7h electrically connects to the ground terminals 7d projecting from inside, avoiding the contact terminals 4f, 5b and 6b. In the relay if shown in FIG. 6A to FIG. 6C, a large metal plate 7h connected with the ground terminals 7d is so provided as to avoid the contact terminals 4f, 5b and 6b to an extent that the contact terminals 4f, 5b and 6b do not short.

Further, Japanese Laid-Open Patent Application No. 2000-340084 proposes a relay 1g, as shown in FIG. 7A and FIG. 7B, (the body of) which is covered by a metal case (a conductor cover) 9 provided with the ground terminals 7d.

However, the heretofore-described conventional relays do not necessarily provide a satisfactory isolation characteristic.

### SUMMARY OF THE INVENTION

It is a general object of the present invention to provide an improved and useful high-frequency relay in which the above-mentioned problems are eliminated.

A more specific object of the present invention is to provide a high-frequency relay that exhibits an excellent isolation characteristic.

In order to achieve the above-mentioned objects, there is provided according to one aspect of the present invention a high-frequency relay comprising: a body containing a contact unit connected with at least one contact terminal protruded from a bottom surface of the body, the contact unit having contact states switched according as an energization to a coil; and a base covering at least the bottom surface, the base having a grounding function and including a conductive layer.

According to the present invention, the high-frequency relay can exhibit an excellent isolation characteristic.

More preferably, in the high-frequency relay according to the present invention, the base may be formed in a box shape covering the bottom surface and four side surfaces of the body, the box shape having an upward opening.

More preferably, the high-frequency relay according to the present invention may further comprise an openable and closable lid member capable of being closed on the upward opening, the lid member including a conductive layer so as to be electrically connected with the base.

More preferably, the high-frequency relay according to the present invention may further comprise a cover capable of covering surfaces of the body except the bottom surface, the cover including a conductive layer so as to be electrically connected with the base.

In order to achieve the above-mentioned objects, there is also provided according to another aspect of the present invention a high-frequency relay comprising: a body containing a contact unit connected with at least one contact terminal protruded from a bottom surface of the body, the contact unit having contact states switched according as an energization to a coil; a cover capable of covering surfaces of the body except the bottom surface, the cover having a grounding function and including a conductive layer; and a base covering at least the bottom surface, the base including a conductive layer so as to be electrically connected with the cover.

More preferably, in the high-frequency relay according to the present invention, one of the base and the cover may include a ground terminal having the grounding function. Alternatively, the base may include a mounting pad so as to be mounted on a substrate, the mounting pad having the grounding function.

Additionally, in the high-frequency relay according to the present invention, the base may be composed of a resinous molding coated with the conductive layer.

More preferably, in the high-frequency relay according to the present invention, the base may include at least one insertion hole accommodating the contact terminal inserted therethrough.

More preferably, in the high-frequency relay according to the present invention, the base may be formed from a metal plate by bending so as to comprise a ground terminal bent from a bottom surface of the base and a defective part formed in the bottom surface of the base by bending the ground terminal; the cover may be formed from a metal plate by bending so as to comprise a foldable projection capable of being folded with respect to the cover; and the defective part may be closed by the foldable projection.

Additionally, in the high-frequency relay according to the present invention, the cover may be composed of a resinous molding coated with the conductive layer.

More preferably, in the high-frequency relay according to the present invention, the cover and the base may comprise respective engaging members so that the cover and the base are engaged by the engaging members so as to be unified.

Additionally, in the high-frequency relay according to the present invention, one of the cover and the base may be inserted into the other so as to be unified.

Additionally, in the high-frequency relay according to the present invention, the cover and the base may be bonded to each other so as to be unified.

In order to achieve the above-mentioned objects, there is also provided according to another aspect of the present invention a high-frequency relay comprising: a body containing a contact unit connected with a contact terminal and a ground terminal protruded from a bottom surface of the body, the contact unit having contact states switched according as an energization to a coil; a base covering at least the bottom surface, the base including a conductive layer so as to be electrically connected with the ground terminal; and a cover capable of covering surfaces of the body except the bottom surface, the cover including a conductive layer so as to be electrically connected with the base.

According to the present invention, the ground terminal or the pad need not be especially provided on the base or the cover.

In order to achieve the above-mentioned objects, there is also provided according to another aspect of the present invention a high-frequency relay comprising:

a body containing a contact unit connected with at least one contact terminal protruded from a bottom surface of the body, the contact unit having contact states switched according as an energization to a coil;

a base covering at least the bottom surface, the base including a conductive layer;

a cover capable of covering surfaces of the body except the bottom surface, the cover including a conductive layer;

a ground terminal formed on one of the base and the cover; and

a standoff portion provided on one of the base and the cover.

According to the present invention, when the relay is mounted on a substrate, the base of the relay and a pattern formed on the substrate can surely be prevented from interfering with each other.

Other objects, features and advantages of the present invention will become more apparent from the following detailed description when read in conjunction with the accompanying drawings.

### BRIEF DESCRIPTION OF THE DRAWINGS

FIG. 1A is a diagram roughly illustrating a structure of a conventional relay;

FIG. 1B is a diagram symbolically illustrating the conventional relay shown in FIG. 1A;

FIG. 2 is a diagram symbolically illustrating another conventional relay different from the relay shown in FIG. 1A and FIG. 1B;

FIG. 3 is a diagram roughly illustrating a structure of still another conventional relay;

FIG. 4 is a perspective view roughly illustrating a structure of still another conventional relay;

FIG. 5A is a side view illustrating still another conventional relay, transparently in part;

FIG. 5B is another side view of the conventional relay shown in FIG. 5A;

FIG. 5C is a bottom view of the conventional relay shown in FIG. 5A;

FIG. 6A is a side view illustrating still another conventional relay, transparently in part;

FIG. 6B is another side view of the conventional relay shown in FIG. 6A;

FIG. 6C is a bottom view of the conventional relay shown in FIG. 6A;

FIG. 7A is a diagram roughly illustrating a structure of still another conventional relay;

FIG. 7B is an exploded perspective view of the conventional relay shown in FIG. 7A;

FIG. 8A is a diagram roughly illustrating a structure of a relay according to a first embodiment of the present invention;

FIG. 8B is an exploded perspective view of the relay shown in FIG. 8A;

FIG. 8C is a perspective view of the relay shown in FIG. 8A;

FIG. 9 is a diagram for explaining a method for forming a base shown in FIG. 8A to FIG. 8C from a metal plate by deep drawing;

FIG. 10 is a diagram of the base shown in FIG. 9 with ground terminals mounted thereto;

FIG. 11 is a diagram for explaining a method for forming the base shown in FIG. 8A to FIG. 8C from a metal plate by bending;

FIG. 12 is a diagram for explaining a method for forming the base shown in FIG. 8A to FIG. 8C by bending a metal plate provided with ground terminals;

FIG. 13 is a diagram for explaining another form of ground terminals different from the ground terminals shown in FIG. 12;

FIG. 14 is a diagram for explaining still another form of ground terminals different from the ground terminals shown in FIG. 12 and FIG. 13;

FIG. 15 is a diagram for explaining a form of the base provided with a projection formed as a pad;

FIG. 16 is a diagram for explaining a form of the base provided with a conductive portion formed as a pad;

FIG. 17 is a diagram for explaining still another form of ground terminals;

FIG. 18 is a diagram for explaining still another form of ground terminals;

FIG. 19A and FIG. 19B are diagrams for explaining a method for forming the base including a box member molded from a resin;

FIG. 20 is a perspective view of a base of a relay according to a second embodiment of the present invention, the base being provided with ground terminals;

FIG. 21 is a perspective view of the base shown in FIG. 20 provided with another form of ground terminals different from the ground terminals shown in FIG. 20;

FIG. 22 is a perspective view of the base shown in FIG. 20 provided with still another form of ground terminals;

FIG. 23 is a perspective view of the base shown in FIG. 20 provided with still another form of ground terminals;

FIG. 24A is a perspective view of a form of the base provided with a projection formed as a pad;

FIG. 24B is a perspective view of the base shown in FIG. 24A attached to a body of the relay according to the second embodiment of the present invention;

FIG. 25 is a diagram for explaining a form of the base provided with a conductive portion formed as a pad;

FIG. 26A is an exploded perspective view of a relay according to a third embodiment of the present invention;

FIG. 26B is a perspective view of the relay with a lid member yet to be closed;

FIG. 26C is a perspective view of the relay with the lid member closed;

FIG. 27A is an exploded perspective view of a relay according to a fourth embodiment of the present invention;

FIG. 27B is a perspective view of an assembly of the relay shown in FIG. 27A;

FIG. 28 is a diagram for explaining a method for forming a cover shown in FIG. 27A and FIG. 27B from a metal plate by deep drawing;

FIG. 29 is a diagram for explaining a method for forming the cover shown in FIG. 27A and FIG. 27B from a metal plate by bending;

FIG. 30A is an exploded perspective view of a relay according to a fifth embodiment of the present invention;

FIG. 30B is an inverted perspective view of an assembly of the relay shown in FIG. 30A;

FIG. 31 is a diagram of an example of insertion structures of the base and the cover according to the present invention;

FIG. 32 is a diagram of another example of insertion structures of the base and the cover according to the present invention;

FIG. 33A and FIG. 33B are diagrams of an example of engaging structures for the base and the cover according to the present invention, using engaging members;

FIG. 34A and FIG. 34B are diagrams of another example of engaging structures for the base and the cover according to the present invention;

FIG. 35A and FIG. 35B are diagrams of still another example of engaging structures for the base and the cover according to the present invention;

FIG. 36A and FIG. 36B are diagrams of still another example of engaging structures for the base and the cover according to the present invention;

FIG. 37A and FIG. 37B are diagrams of still another example of engaging structures for the base and the cover according to the present invention;

FIG. 38A and FIG. 38B are diagrams of an example of engaging structures for the base and the body according to the present invention, using engaging members;

FIG. 39A and FIG. 39B are diagrams of another example of engaging structures for the base and the body according to the present invention;

FIG. 40 is a diagram for explaining a method for unifying the base, the cover and the body of the relay by using a liquid adhesive;

FIG. 41A is an exploded perspective view of the relay seen from one side, which explains a method for unifying the base, the cover and the body of the relay by using a solid adhesive;

FIG. 41B is an exploded perspective view of the relay shown in FIG. 41A, as seen from another side;

FIG. 41C is a perspective view of the solid adhesive shown in FIG. 41A and FIG. 41B;

FIG. 42 is a diagram of an example of insertion holes formed in the base through which terminals of the body are inserted;

FIG. 43 is a diagram of another example of insertion holes formed in the base;

FIG. 44 is a diagram of still another example of insertion holes formed in the base;

FIG. 45 is a diagram of still another example of insertion holes formed in the base;

FIG. 46A is a diagram roughly illustrating a structure of the relay, which explains an example of a structure in which ground terminals provided on the body are engaged in engaging holes formed in the base;

FIG. 46B is a diagram of the engaging holes;

FIG. 46C is a diagram of the ground terminals being engaged in the engaging holes;

FIG. 47 is a diagram of another example of the engaging holes;

FIG. 48A is a perspective view of an example of the cover provided with standoff portions;

FIG. 48B is a perspective view of the cover shown in FIG. 48A inserted into the base to form a relay;

FIG. 48C is a perspective view of the relay shown in FIG. 48B mounted on a substrate;

FIG. 49A is a perspective view of an example of the base provided with standoff portions;

FIG. 49B is a perspective view of the base shown in FIG. 49A covered with the cover to form a relay;

FIG. 50A is a perspective view of another example of the cover provided with standoff portions;

FIG. 50B is a sectional view of the cover shown in FIG. 50A;

FIG. 51A is a perspective view of another example of the base provided with standoff portions;

FIG. 51B is a sectional view of the base shown in FIG. 51A; and

FIG. 52 is a graph representing isolation characteristics of the conventional relays and the relays according to the present invention.

### DETAILED DESCRIPTION OF THE PREFERRED EMBODIMENTS

A description will now be given, with reference to the drawings, of embodiments of a high-frequency relay (hereinafter simply referred to as a relay) according to the present invention.

It is noted here that, since each of the relays according to the following embodiments has the same basic structure as the foregoing conventional relays, the same elements will be referenced by the same reference marks, if not especially mentioned; or, as occasion demands, the elements will not be specifically referenced by the reference marks or will not be shown in the figures, and will not be described in detail.

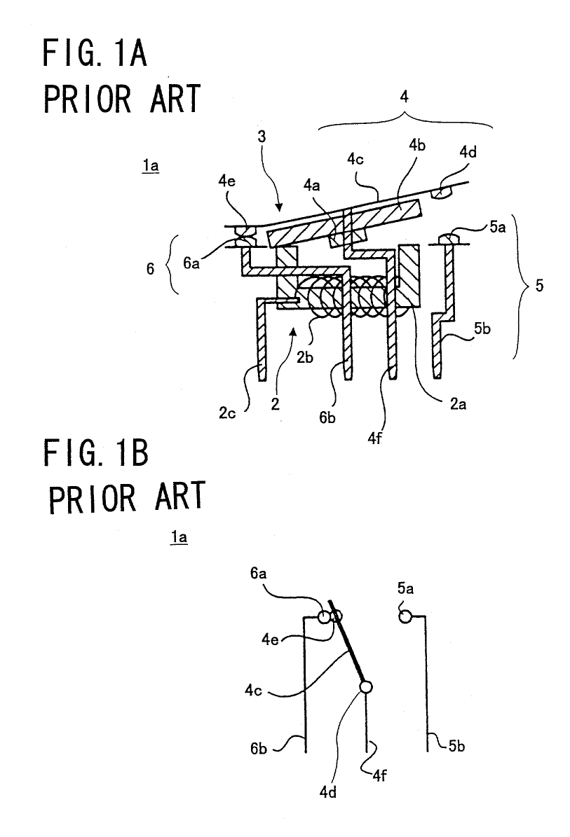

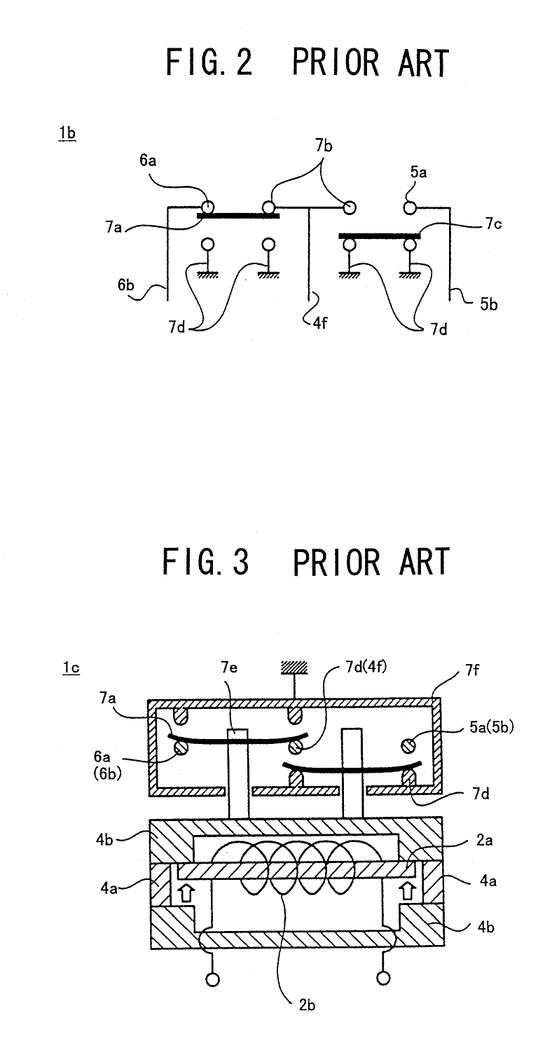

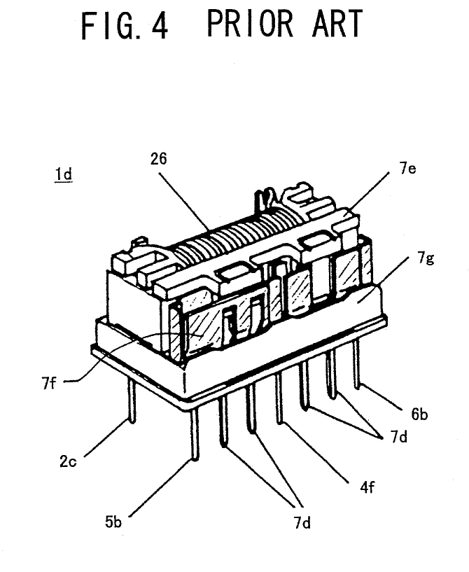

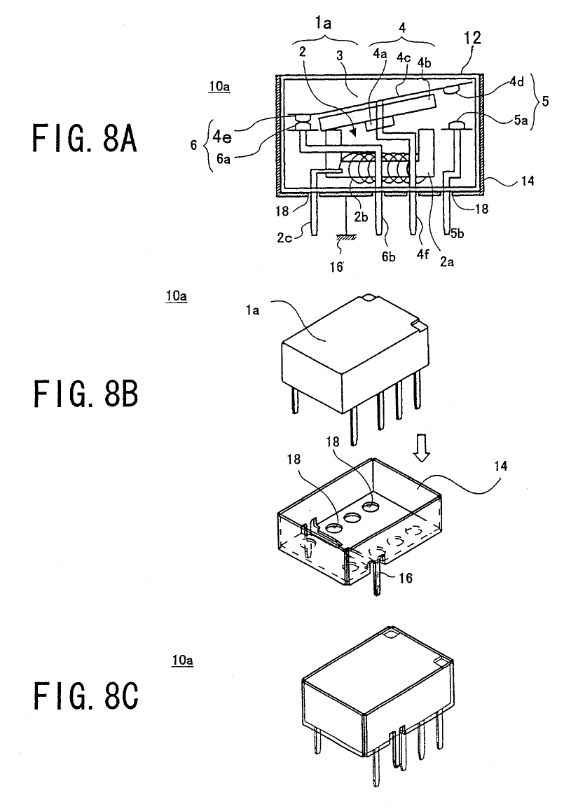

As shown in FIG. 8A to FIG. 8C, a relay 10a according to a first embodiment of the present invention is a relay in which the present invention is applied to the conventional relay 1a shown in FIG. 1A.

The relay 10a comprises the body 1a of the relay, and a metal base 14. The body 1a contains the contact unit 3 in which the contact (make/break) state switches according as an energization to the coil 2b. The contact terminals 4f, 5b and 6b connected to the contact unit 3, and the coil terminal 2c, are protruded from a bottom surface of a resinous cover 12 covering these elements. The metal base 14 is formed in a box shape covering a bottom surface and four sides of the body 1a and opening upward. Ground terminals 16 realizing a grounding function are mounted on the base 14. The ground terminals 16 are terminals inserted into through holes of a substrate not shown in the figure. Insertion holes 18 are formed in a bottom surface of the base 14. The terminals 2c, 4f, 5b and 6b of the body 1a are inserted through the respective insertion holes 18.

The relay 10a according to the present first embodiment exhibits an excellent isolation characteristic.

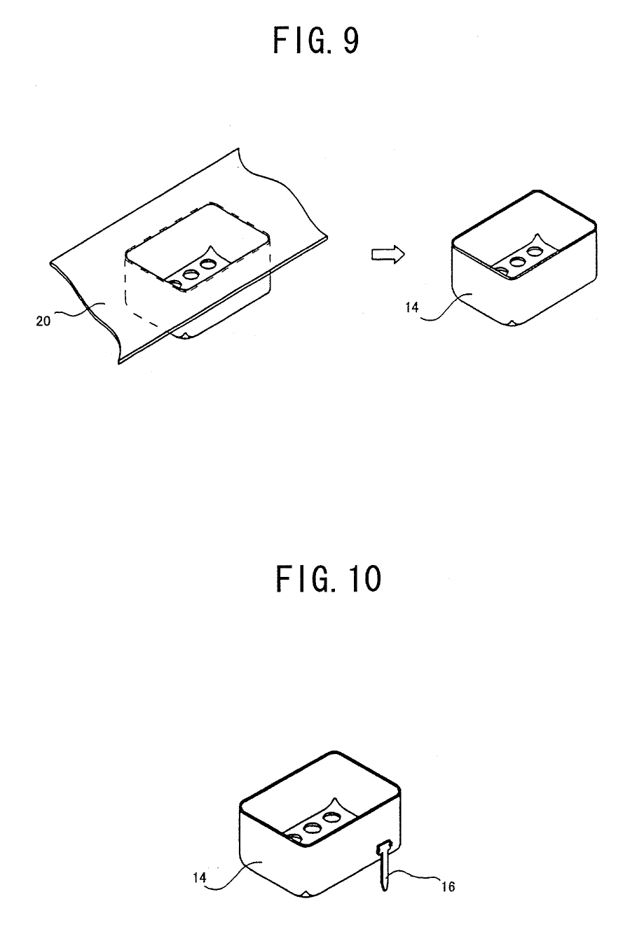

The base 14 of the relay 10a according to the present first embodiment can be formed from a metal plate 20 into the box shape by deep drawing, for example as shown in FIG. 9. Then, for example as shown in FIG. 10, the ground terminals 16 are mounted on the metal base 14 by welding. In this case, each of five planes of the base 14 formed by deep drawing has no gaps; this contributes to improving the isolation characteristic.

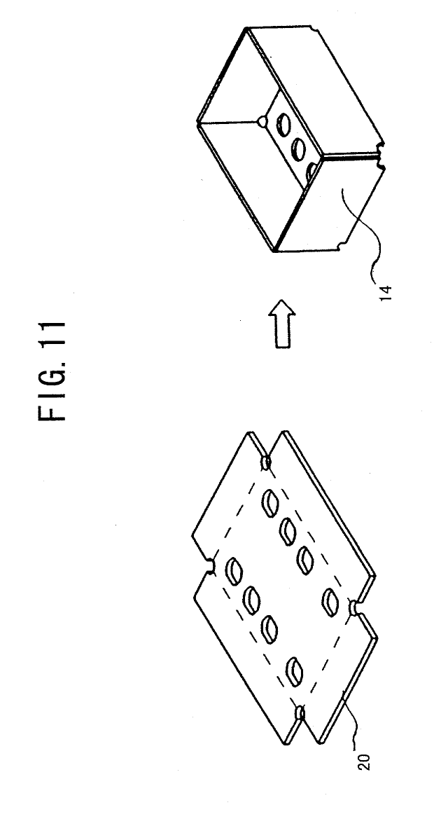

Alternatively, the base 14 of the relay 10a can be formed from the metal plate 20 into the box shape by bending, for example as shown in FIG. 11. Then, the ground terminals 16 are mounted on the metal base 14 by welding, in the same manner as in FIG. 10.

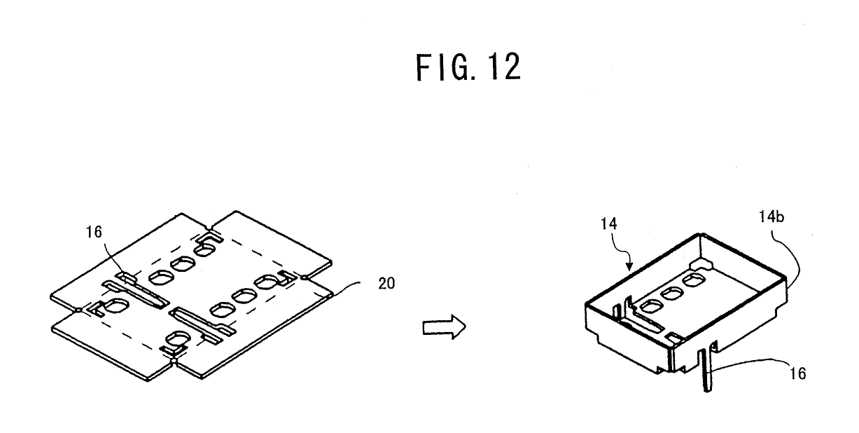

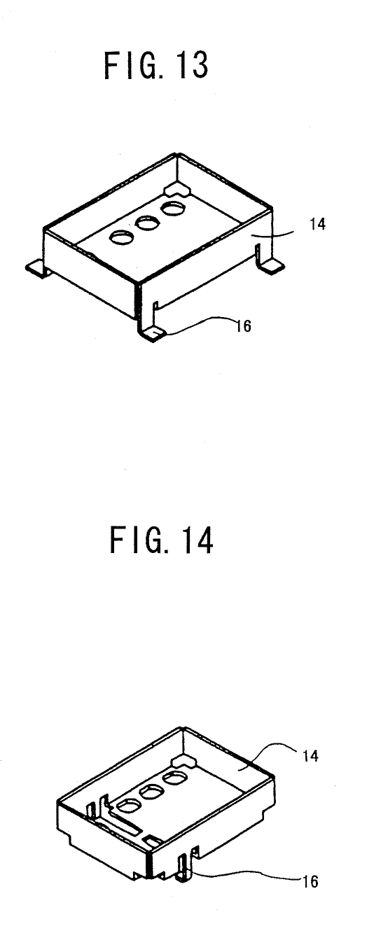

In this course, for example as shown in FIG. 12, the ground terminals 16 may be formed beforehand unitarily with the metal plate 20 so that starting portions of the ground terminals 16 are located at parts of the metal plate 20 corresponding to sides of the base 14. With this arrangement, at the same time that sides 14b of the base 14 are formed by bending up the parts of the metal plate 20 corresponding to the sides of the base 14, the ground terminals 16 are so formed as to hang down from the sides 14b. Additionally, the ground terminals 16 may be formed as surface mount terminals by bending end portions of the ground terminals 16 outwardly as shown in FIG. 13, or by bending the end portions of the ground terminals 16 inwardly as shown in FIG. 14.

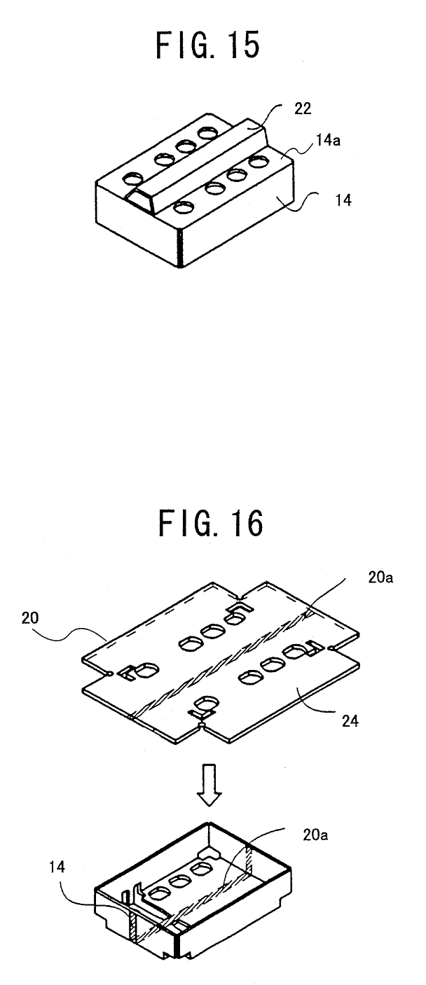

Alternatively as a structure having a grounding function, a line of projection 22 may be formed as a pad (a ground connection portion) on a bottom surface 14a of the base 14, as shown in FIG. 15. Still alternatively, an insulating coating 24 may be applied throughout the surface of the metal plate 20 except a line of conductive portion 20a to be left as a pad (a ground connection portion) on the metal plate 20, as shown in FIG. 16.

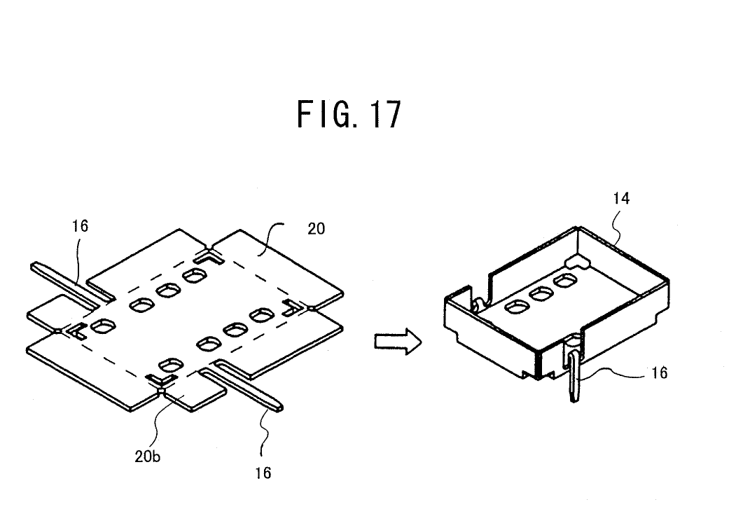

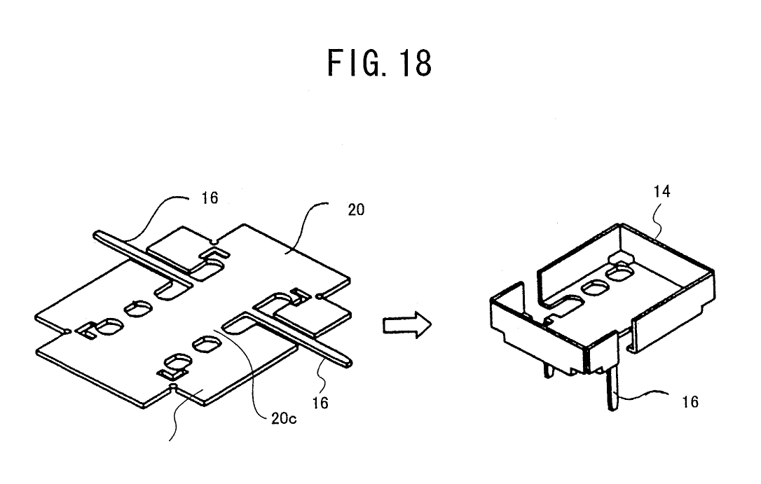

Additionally, the ground terminals 16 may be formed by being bent from the metal plate 20. For example, as shown in FIG. 17, the ground terminals 16 may be formed long at bent-up parts (parts of the metal plate 20 to become the sides of the base 14) 20b. Then, after the bent-up parts 20b are bent up together with the ground terminals 16, the ground terminals 16 alone may be bent down so at to become substantially U-shaped. Alternatively, as shown in FIG. 18, the ground terminals 16 may be formed long unitarily with the metal plate 20 with starting portions of the ground terminals 16 being located at a part 20c of the metal plate 20 to become the bottom surface 14a of the base 14. Then, whereas the bent-up parts 20b are bent up, the ground terminals 16 may be bent down oppositely.

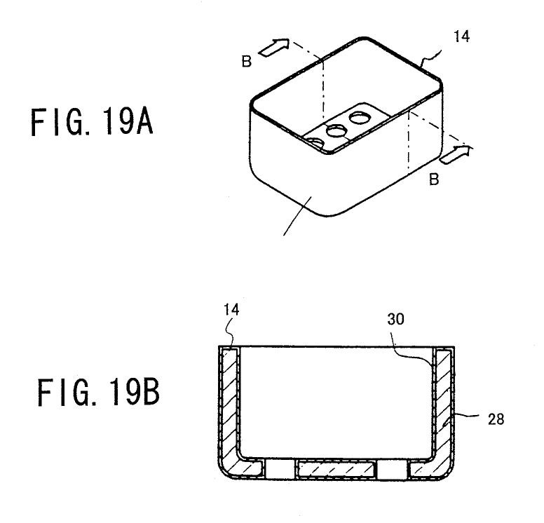

Still alternatively, the base 14 of the relay 10a may be formed as follows: a box member 28 is formed by molding a resin; and a metal film (a conductive layer) 30 is formed on the surface of the box member 28 by plating or coating the surface of the box member 28, as shown in FIG. 19A and FIG. 19B. Then, the ground terminals 16 are mounted on the metal base 14 by welding, in the same manner as in FIG. 10, for example.

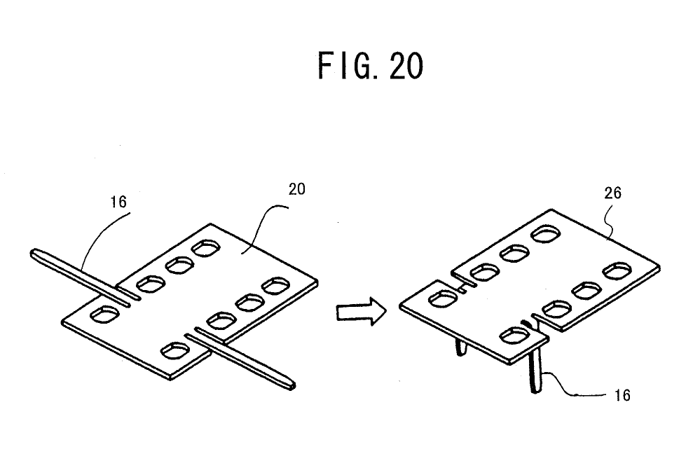

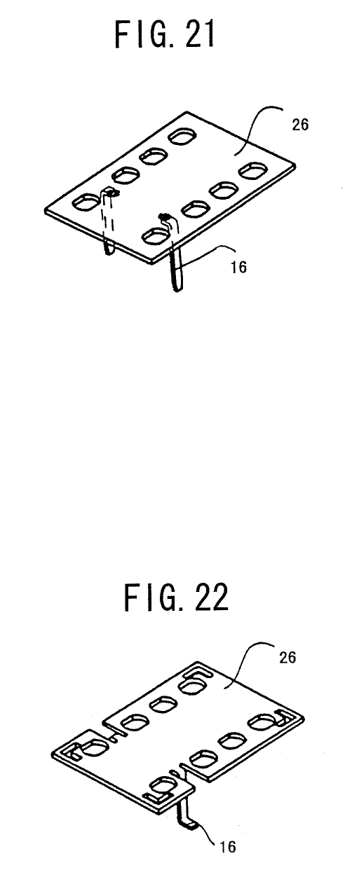

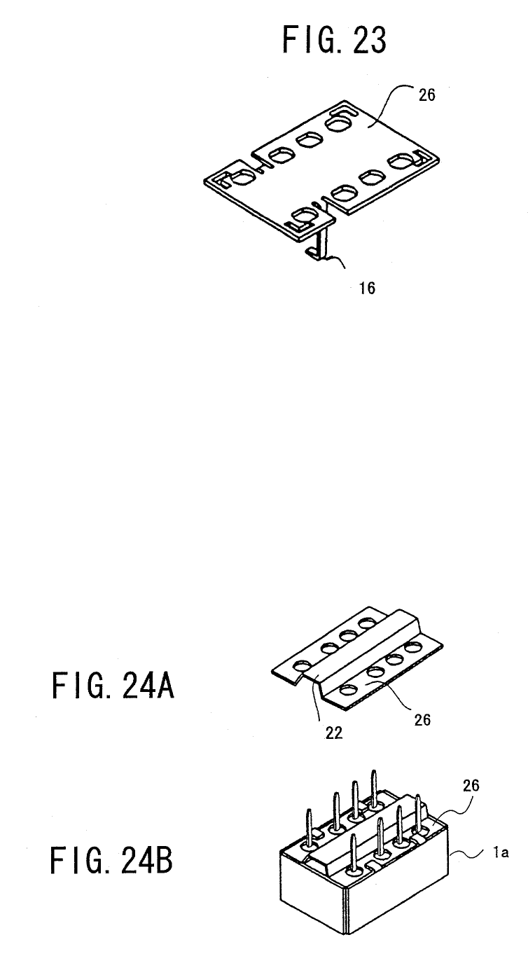

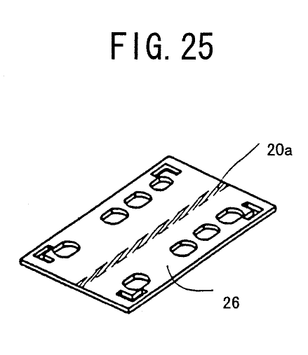

Next, a relay according to a second embodiment of the present invention is different from the relay 10a according to the foregoing first embodiment in that the metal base 14 formed in the box shape is replaced by a base 26 formed in a shape having a bottom plate (a bottom surface) alone. Additionally, for example, the ground terminals 16 may be formed as shown in FIG. 20 corresponding to FIG. 18. Still additionally, for example, the ground terminals 16 may be welded on the base 26, as shown in FIG. 21. Still additionally, the ground terminals 16 may be formed as surface mount terminals by bending the end portions of the ground terminals 16 outwardly as shown in FIG. 22 corresponding to FIG. 13, or by bending the end portions of the ground terminals 16 inwardly as shown in FIG. 23 corresponding to FIG. 14. Further, the projection 22 may be formed as a pad (a ground connection portion), as shown in FIG. 24A and FIG. 24B corresponding to FIG. 15. Still further, the conductive portion 20a may be formed as a pad (a ground connection portion), as shown in FIG. 25 corresponding to FIG. 16.

As described above, the relay according to the present second embodiment has a simple structure that can provide a substantially equivalent advantage to the advantage provided by the relay 10a according to the foregoing first embodiment.

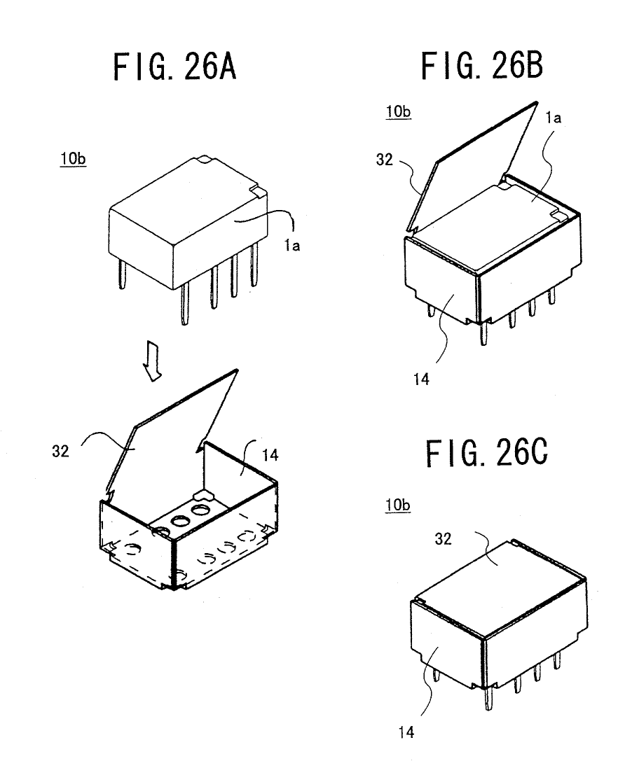

Next, a relay 10b according to a third embodiment of the present invention has a structure in which an openable and closable lid member 32 is provided on one of the sides 14b of the base 14, as shown in FIG. 26A to FIG. 26C, in addition to the structure of the relay 10a according to the foregoing first embodiment. The lid member 32 includes a conductive layer, such as a metal film, and is electrically connected with the base 14. After the body 1a is contained in the base 14 formed in the box shape, as shown in FIG. 26A and FIG. 26B, the lid member 32 is closed so as to shut the upward opening; thereby, the body 1a is covered tightly with the base 14 and the lid member 32, as shown in FIG. 26C.

The relay 10b according to the present third embodiment exhibits a more excellent isolation characteristic than the relay 10a according to the foregoing first embodiment.

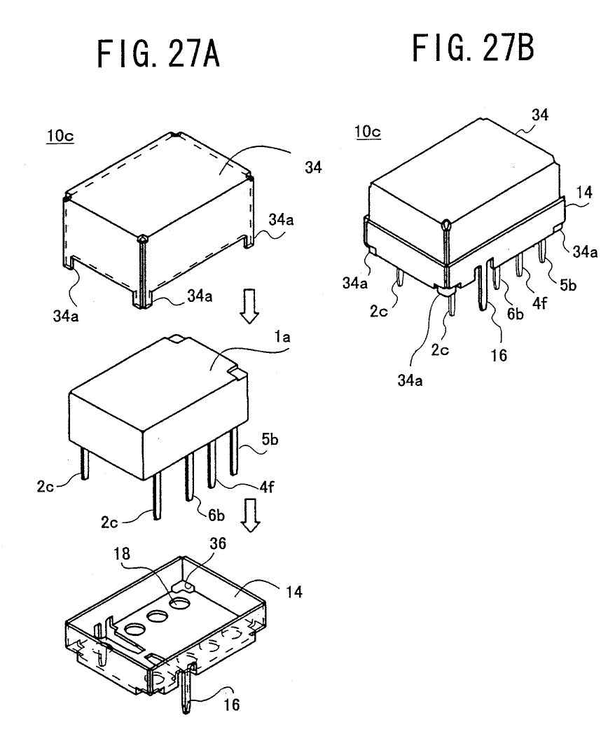

Next, a relay 10c according to a fourth embodiment of the present invention comprises a metal cover 34 formed in a box shape opening downward, as shown in FIG. 27A and FIG. 27B, together with the base 14 of the relay 10a according to the foregoing first embodiment.

The cover 34 has standoff portions 34a at four corners of lower edges of sides thereof. On the other hand, holes 36 are so formed in the base 14 that the standoff portions 34a pass through the respective holes 36.

After the body 1a is contained in the base 14, the cover 34 is inserted along inner side surfaces of the base 14. In this course, the standoff portions 34a are inserted through the respective holes 36. Thereby, the body 1a is covered tightly with the base 14 and the cover 34.

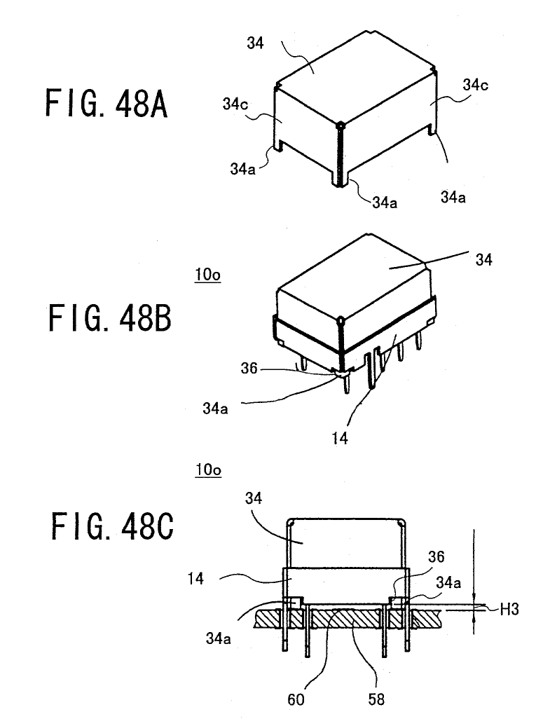

The relay 10c according to the present fourth embodiment provides a similar advantage to the advantage provided by the relay 10b according to the foregoing third embodiment. Additionally, when the relay 10c is mounted on the substrate not shown in the figure by inserting the terminals through the through holes of the substrate to protrude from the undersurface of the substrate, the standoff portions 34a provided in the relay 10c can surely prevent the base 14 and a pattern formed on the substrate from interfering with each other, because the standoff portions 34a contact the upper surface of the substrate so as to create a gap between the relay 10c and the substrate. (This point will be hereinafter described in detail with reference to FIG. 48A to FIG. 48C.) Additionally, in the relay 10c, the ground terminals 16 may be formed on the cover 34, instead of being formed on the base 14, such that the ground terminals 16 pass through holes formed in the base 14 (not shown in the figures). Additionally, the standoff portions 34a may be formed on the base 14.

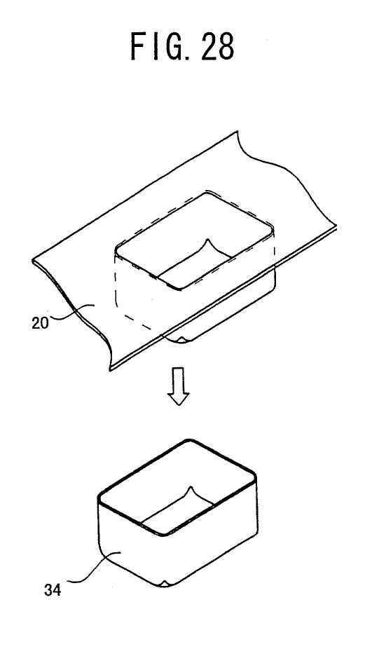

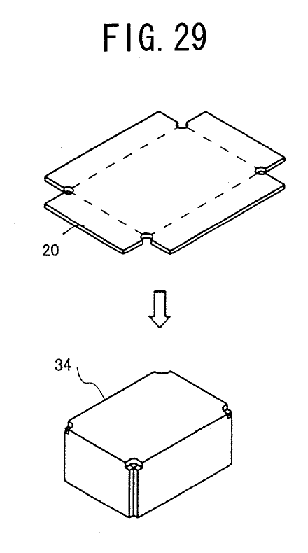

The cover 34 of the relay 10c according to the present fourth embodiment can be formed from the metal plate 20 by deep drawing, for example as shown in FIG. 28. Alternatively, the cover 34 can be formed from the metal plate 20 by bending, for example as shown in FIG. 29.

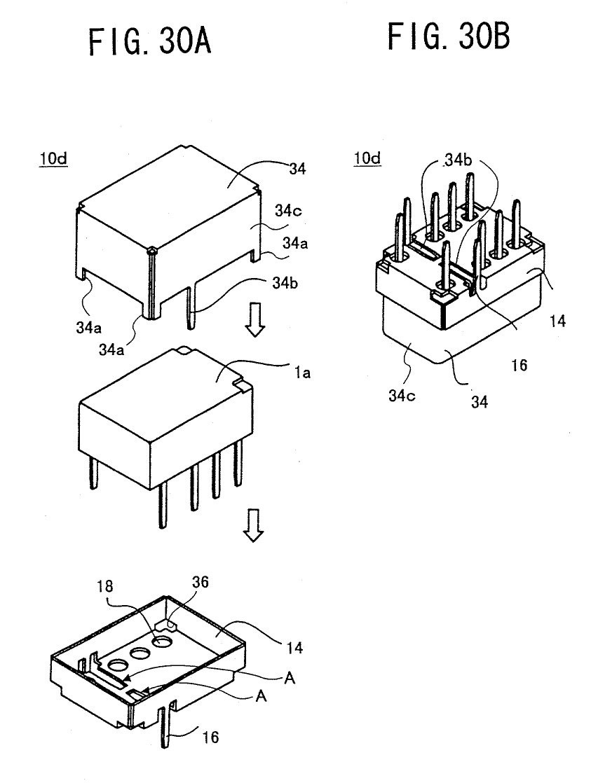

Next, as shown in FIG. 30A and FIG. 30B, a relay 10d according to a fifth embodiment of the present invention has substantially the same structure as the relay 10c according to the foregoing fourth embodiment, but is different from the relay 10c in that long foldable projections 34b are provided on opposing sides 34c of the cover 34.

Each of the base 14 and the cover 34 is formed from the metal plate by bending, and the ground terminals 16 of the base 14 are bent from the metal plate. In this course, bending the ground terminals 16 leaves defective parts, i.e., openings (indicated by arrows A in FIG. 30A) in the bottom surface 14a of the base 14. However, when the cover 34 containing the body 1a is inserted into the base 14, the foldable projections 34b are bent inwardly so that the openings A are closed by the foldable projections 34b. Thereby, the body 1a can be covered more tightly.

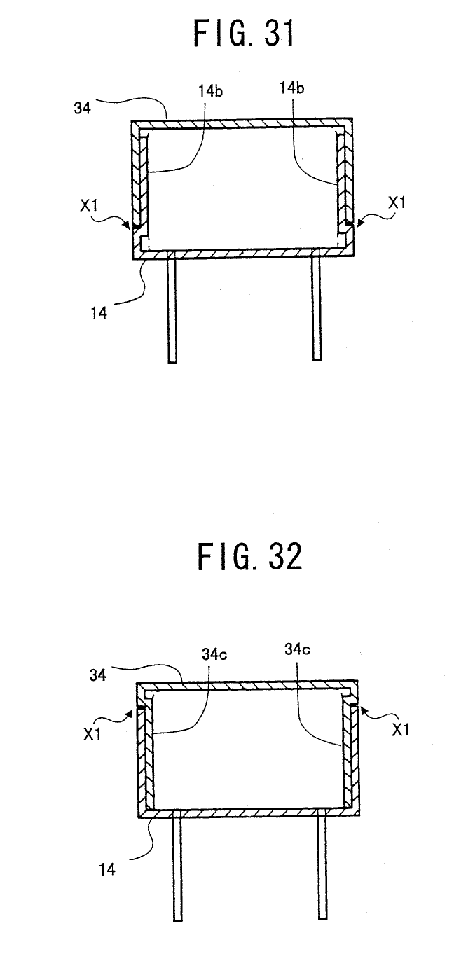

Besides, in the heretofore-described embodiments, the base and the cover are unified by using insertion methods and structures. As such insertion structures, it is more preferable that the sides 14b of the base 14 to be inserted into the cover 34 are so formed as to have steps (indicated by arrows X1) near lower ends of the sides 14b, as shown in FIG. 31, or that the sides 34c of the cover 34 to be inserted into the base 14 are so formed as to have steps (indicated by arrows X1) near upper ends of the sides 34c, as shown in FIG. 32. Accordingly, upon insertion of the base/the cover, the steps function as stoppers so as to accurately position the base and the cover.

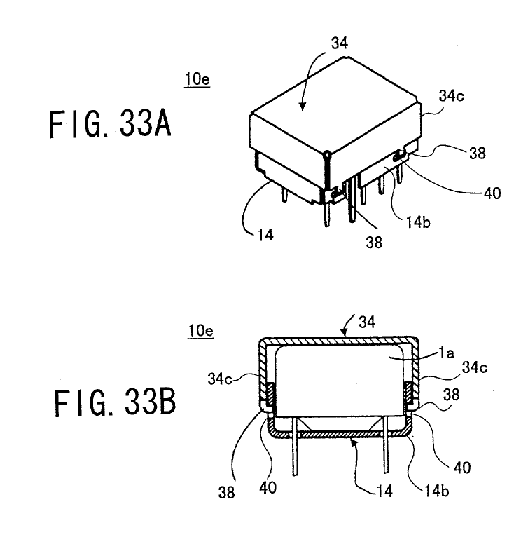

Here, descriptions will be given, with reference to FIG. 33A to FIG. 37B, of other methods and structures for unifying the base and the cover by using respective engaging members.

In a relay 10e shown in FIG. 33A and FIG. 33B, a plurality of hooks 38 are provided on lower edges of the sides 34c of the cover 34, and a plurality of holes 40 are formed in the sides 14b of the base 14.

In the course of unifying the base and the cover of the relay 10e, after the body 1a is contained in the base 14, the cover 34 is put on the base 14 with the hooks 38 contacting smoothly on the sides 14b; then, the hooks 38 engage the holes 40 so as to fix the cover 34 to the base 14 unitarily.

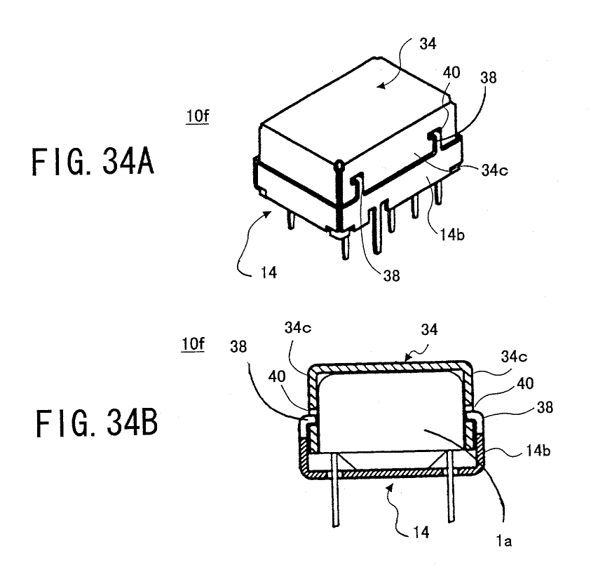

In a relay 10f shown in FIG. 34A and FIG. 34B, the holes 40 are formed in the sides 34c of the cover 34, and the hooks 38 are provided on upper edges of the sides 14b of the base 14, contrary to the relay 10e.

In the course of unifying the base and the cover of the relay 10f, the cover 34 containing the body 1a is inserted into the base 14 with the hooks 38 contacting smoothly on the sides 34c; then, the hooks 38 engage the holes 40 so as to fix the cover 34 to the base 14 unitarily.

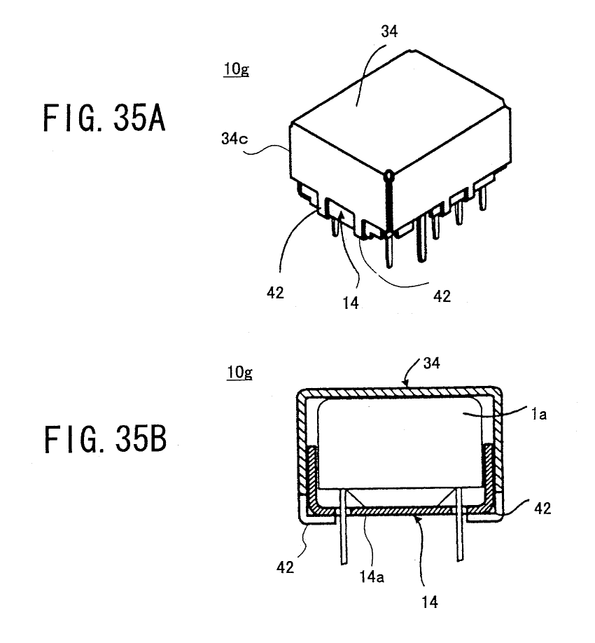

In a relay 10g shown in FIG. 35A and FIG. 35B, a plurality of foldable long projections (terminals) 42 are provided on the lower edges of the sides 34c of the cover 34.

In the course of unifying the base and the cover of the relay 10g, after the body 1a is contained in the base 14, the cover 34 is put on the base 14, and then, the long projections 42 are bent inwardly so as to engage the bottom surface 14a of the base 14; thereby, the cover 34 is fixed to the base 14 unitarily.

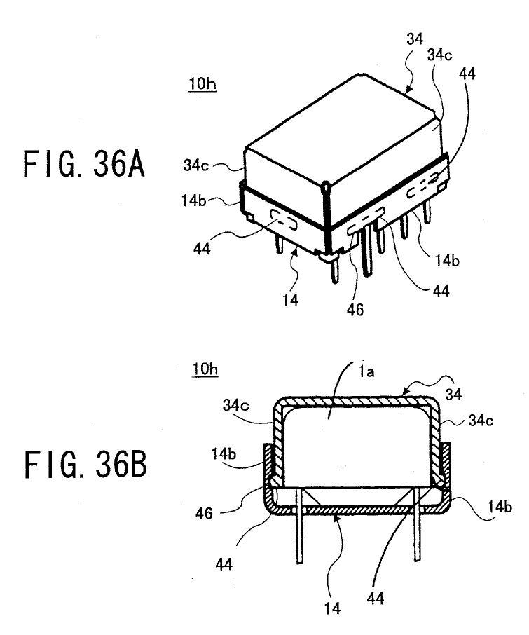

In a relay 10h shown in FIG. 36A and FIG. 36B, a plurality of belt-shaped projections 44 are provided on outer surfaces of the sides 34c of the cover 34, and a plurality of belt-shaped holes 46 are provided on inner surfaces of the sides 14b of the base 14.

In the course of unifying the base and the cover of the relay 10h, the cover 34 containing the body 1a is inserted into the base 14 with the belt-shaped projections 44 of the cover 34 contacting smoothly on inner surfaces of the sides 14b of the base 14 until the belt-shaped projections 44 engage the belt-shaped holes 46; thereby, the cover 34 is fixed to the base 14 unitarily.

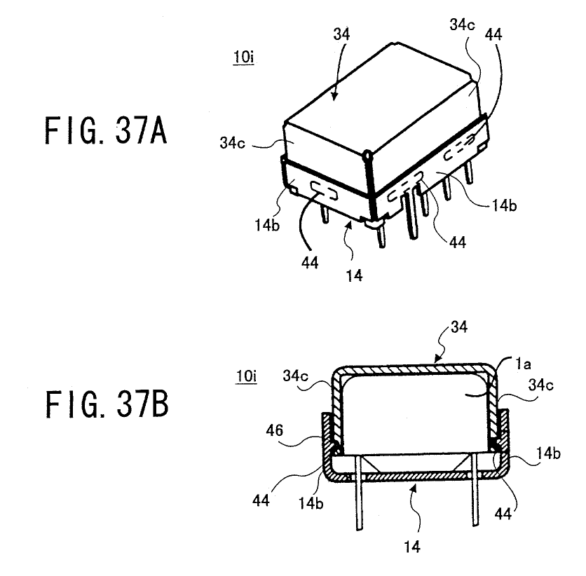

In a relay 10i shown in FIG. 37A and FIG. 37B, the belt-shaped holes 46 are provided on the outer surfaces of the sides 34c of the cover 34, and the belt-shaped projections 44 are provided on the inner surfaces of the sides 14b of the base 14, contrary to the relay 10h.

In the course of unifying the base and the cover of the relay 10i, the cover 34 containing the body 1a is inserted into the base 14 with the sides 34c of the cover 34 contacting smoothly on the belt-shaped projections 44 of the base 14 until the belt-shaped projections 44 engage the belt-shaped holes 46; thereby, the cover 34 is fixed to the base 14 unitarily.

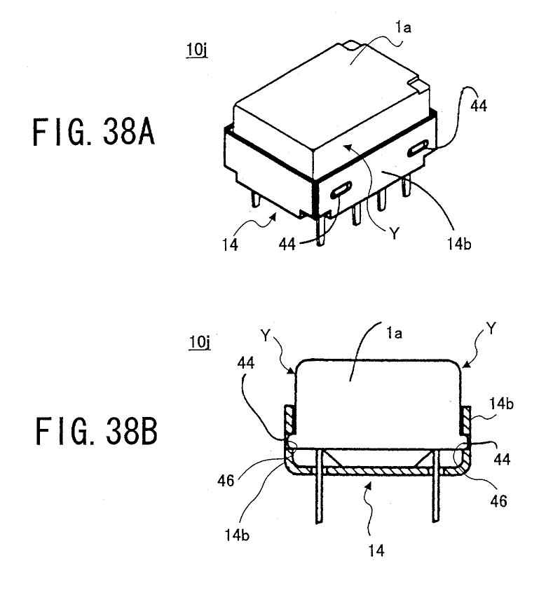

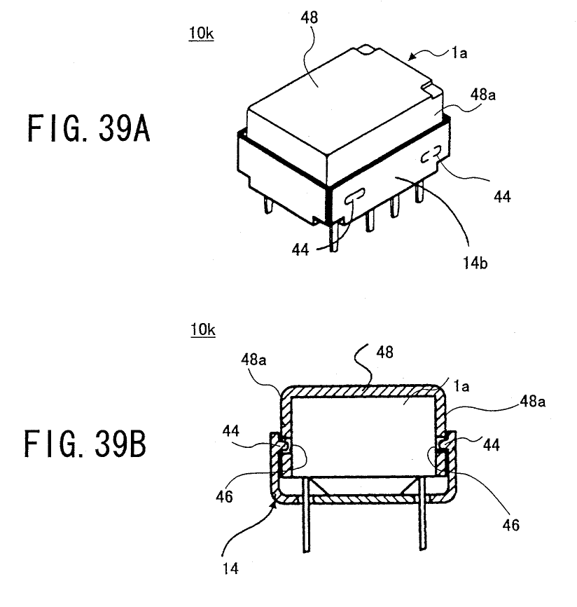

Besides, in the heretofore-described embodiments, the body of the relay is contained in and unified with the base or the cover by using insertion methods and structures. Here, descriptions will be given, with reference to FIG. 38A to FIG. 39B, of other methods and structures for containing and unifying the body of the relay in/with the base or the cover.

In a relay 10j shown in FIG. 38A and FIG. 38B, the belt-shaped projections 44 are provided on outer side surfaces (indicated by arrows Y) of the body 1a, and the belt-shaped holes 46 are provided on the inner surfaces of the sides 14b of the base 14.

In the course of containing and unifying the body in/with the base of the relay 10j, the body 1a is inserted into the base 14 with the belt-shaped projections 44 of the body 1a pushing open the sides 14b of the base 14 until the belt-shaped projections 44 engage the belt-shaped holes 46; thereby, the body 1a is contained in and unified with the base 14.

In a relay 10k shown in FIG. 39A and FIG. 39B, the body 1a is covered with a resinous cover 48, and the belt-shaped holes 46 are provided on outer surfaces of sides 48a of the resinous cover 48. The belt-shaped projections 44 are provided on the inner surfaces of the sides 14b of the base 14.

In the course of containing and unifying the body in/with the base of the relay 10k, the body 1a is inserted into the base 14 with the sides 48a of the resinous cover 48 of the body 1a pushing open the sides 14b of the base 14 with the belt-shaped projections 44 of the base 14 located therebetween until the belt-shaped projections 44 engage the belt-shaped holes 46; thereby, the body 1a is contained in and unified with the base 14.

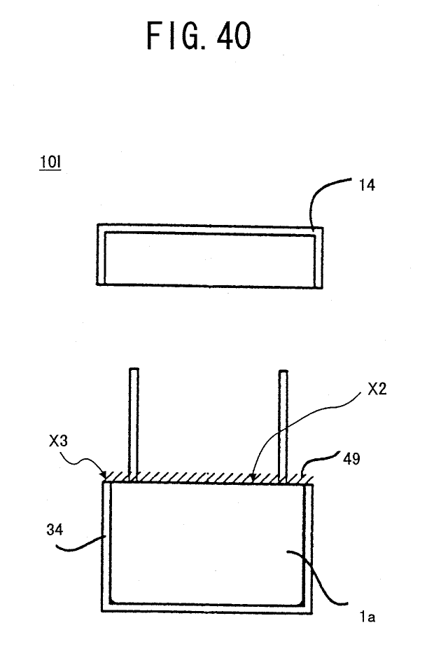

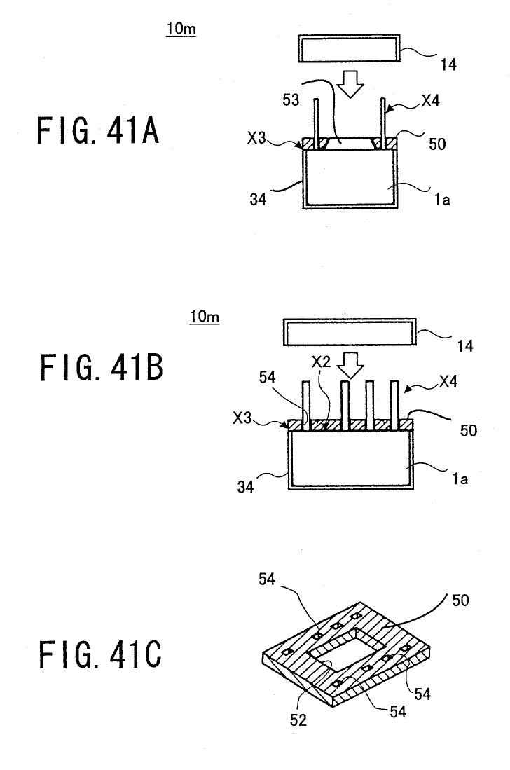

Further, descriptions will be given, with reference to FIG. 40 to FIG. 41C, of methods and structures for fixing and unifying the base, the cover and the body of the relay all at one time.

The base 14, the cover 34 and the body 1a of a relay 101 shown in FIG. 40 are fixed and unified all at one time, as follows: in a state where the body 1a is contained in the cover 34, an epoxy-based liquid adhesive 49, for example, is applied on the bottom surface (indicated by arrow X2) of the body 1a and on peripheral parts (indicated by arrow X3) of the cover 34 in the vicinity of the bottom surface of the body 1a, and thereafter, the base 14 is put on the cover 34. Accordingly, the bottom surface of the body 1a and the peripheral parts of the cover 34 are bonded to inner surfaces of the bottom of the base 14 so that the base 14, the cover 34 and the body 1a are fixed and unified. This structure necessitates no particular engaging structure.

The base 14, the cover 34 and the body 1a of a relay 10m shown in FIG. 41A to FIG. 41C are fixed and unified by being bonded by using a solid adhesive 50 in place of the liquid adhesive 49.

The solid adhesive 50 is formed according to a shape of a bonding part where the body 1a and the cover 34 are bonded to the base 14. Specifically, the solid adhesive 50 has an opening 52 so as to avoid a protuberance 53 located on the bottom surface (indicated by arrow X2) of the body 1a, the protuberance 53 being not required to be bonded. The solid adhesive 50 also has a plurality of openings 54 around the opening 52. The terminals (indicated by arrow X4) of the body 1a are inserted through the respective openings 54. It is noted that the opening 52 will not be formed when the protuberance 53 does not exist on the body 1a.

The base 14, the cover 34 and the body 1a of the relay 10m are fixed and unified all at one time, as follows: in a state where the body 1a is contained in the cover 34, the solid adhesive 50 is applied on the bottom surface (indicated by arrow X2) of the body 1a and on peripheral parts (indicated by arrow X3) of the cover 34 in the vicinity of the bottom surface of the body 1a, and thereafter, the base 14 is put on the cover 34. Then, the relay 10m is heated so as to melt the solid adhesive 50. Thereby, the bottom surface of the body 1a and the peripheral parts of the cover 34 are bonded to inner surfaces of the bottom of the base 14 so that the base 14, the cover 34 and the body 1a are fixed and unified. By using the solid adhesive 50, the base 14, the cover 34 and the body 1a can be bonded more simply than by using the liquid adhesive.

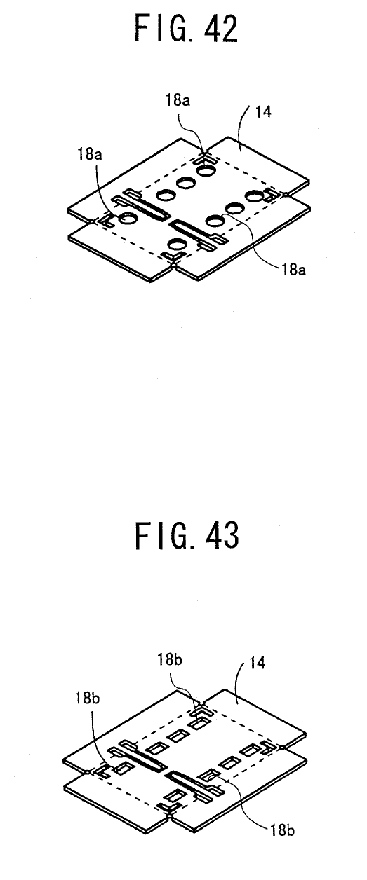

Besides, in the heretofore-described embodiments, the insertion holes 18 through which the terminals of the body 1a are inserted are formed in the base 14. Here, descriptions will be given, with reference to FIG. 42 to FIG. 45, of various forms of the insertion holes including the forms already mentioned hereinabove.

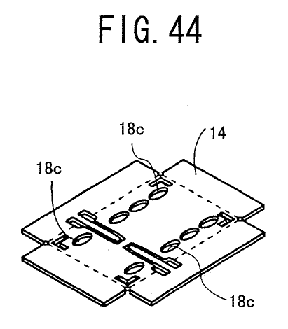

Insertion holes 18a formed in the base 14 shown in FIG. 42 have circular forms. Insertion holes 18b formed in the base 14 shown in FIG. 43 have rectangular forms. Insertion holes 18c formed in the base 14 shown in FIG. 44 have elliptic forms. These forms of the insertion holes 18a to 18c correspond to forms of the terminals inserted thereinto; thus, the insertion holes 18a to 18c are used in accordance with the forms of the terminals.

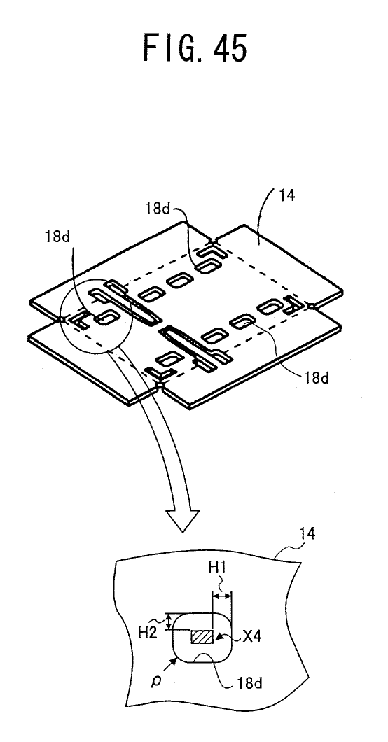

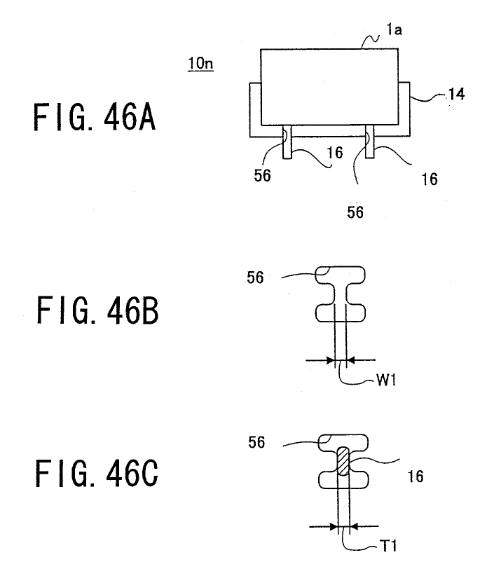

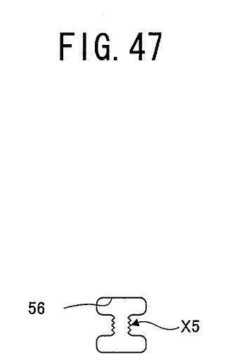

Each of insertion holes 18d formed in the base 14 shown in FIG. 45 has a substantially rectangular form that has curves replacing angles at four corners. Each of these curves has a curvature radius p not larger than gap measurements H1 and H2 between the insertion hole 18d and the terminal (indicated by arrow X4) inserted thereinto Besides, in the heretofore-described embodiments, the ground terminals or the pad (the ground connection portion) are provided on the base or the cover. Here, descriptions will be given, with reference to FIG. 46A to FIG. 47, of examples of using ground terminals of the body of the relay for grounding the base or the cover.

In a relay 10n shown in FIG. 46A to FIG. 46C, a plurality of the ground terminals 16 are provided on the body 1a, and a plurality of engaging holes 56 are formed on the bottom surface 14a of the base 14.

Each of the engaging holes 56 is formed in such a H-shape that a width W1 of a part engaging the ground terminal 16 is formed slightly smaller than a thickness T1 of the ground terminal 16.

In the relay 10n, when the body 1a is inserted into the base 14, the ground terminals 16 of the body 1a are pressed into the respective engaging holes 56 of the base 14. Accordingly, the base 14 surely contacts the ground terminals 16; this enables the ground terminals 16 of the body 1a to be used for grounding the base 14. In this relay 10n, the ground terminals or the pad (the ground connection portion), such as the projection 22 shown in FIG. 15 or the conductive portion 20a shown in FIG. 16 need not be provided especially for the base 14.

Alternatively, in the relay 10n, each of the engaging holes 56 may be so formed that the part (indicated by arrow X5) engaging the ground terminal 16 has a saw-toothed form, as shown in FIG. 47.

Besides, in the heretofore-described embodiments, the standoff portions are provided on the base or the cover. Here, descriptions will be given, with reference to FIG. 48A to FIG. 51B, of various forms of the standoff portions including the forms already mentioned hereinabove.

In a relay 10o shown in FIG. 48A to FIG. 48C, the standoff portions 34a are provided at the four corners of the lower edges of the sides 34c of the cover 34, as shown in FIG. 48A; each of the standoff portions 34a has a predetermined height and an L-shaped cross section. The relay 10o is assembled by inserting the standoff portions 34a into the respective holes 36 of the base 14 containing the body 1a, as shown in FIG. 48B.

When the relay 10o is mounted on a substrate 58, the standoff portions 34a contact the substrate 58 so as to create an insulating gap having a measurement H3 between the base 14 and the substrate 58, as shown in FIG. 48C; thereby, the base 14 and a pattern 60 formed on the substrate 58 can be surely prevented from interfering with each other.

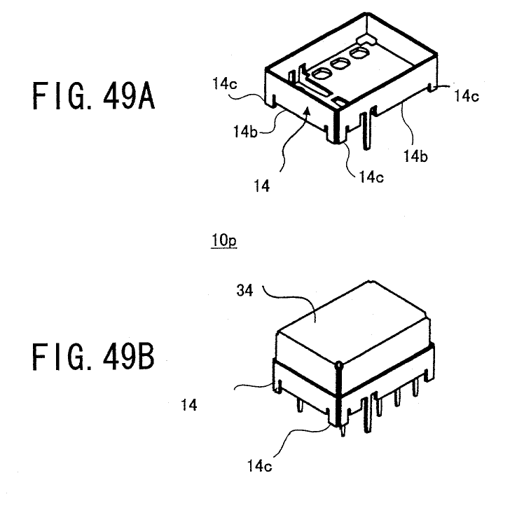

In a relay 10p shown in FIG. 49A to FIG. 49B, standoff portions 14c are provided at four corners of lower edges of the sides 14b of the base 14, as shown in FIG. 49A; each of the standoff portions 14c has an L-shaped cross section.

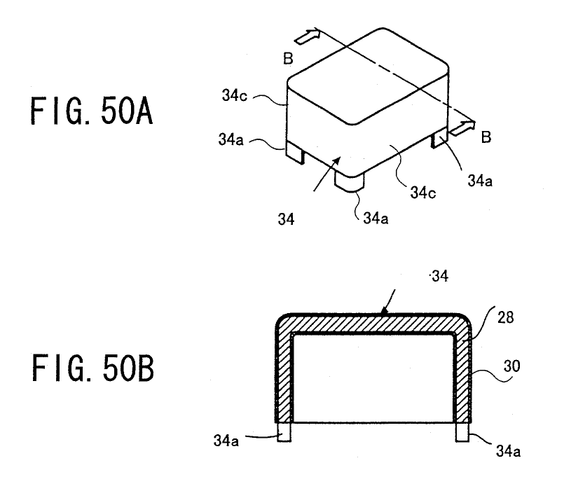

The cover 34 shown in FIG. 50A and FIG. 50B is the box member 28 molded from a resin and coated with the metal film 30 on the surface. Further, in FIG. 50A and FIG. 50B, parts of the metal film 30 are etched off from the standoff portions 34a at the four corners of the lower edges of the sides 34c of the cover 34 so as to expose the box member 28.

Thereby, when the relay is mounted on the substrate, the substrate and the standoff portions 34a are surely insulated from each other; i.e., the substrate and the relay are surely insulated from each other.

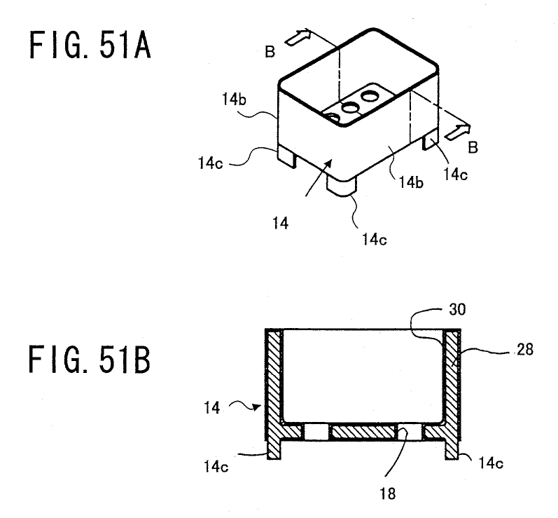

The base 14 shown in FIG. 51A and FIG. 51B is the box member 28 molded from a resin and coated with the metal film 30 on the surface, as is the cover 34 shown in FIG. 50A and FIG. 50B. Further, in FIG. 51A and FIG. 51B, parts of the metal film 30 are etched off from the standoff portions 14c at the four corners of the lower edges of the sides 14b of the base 14.

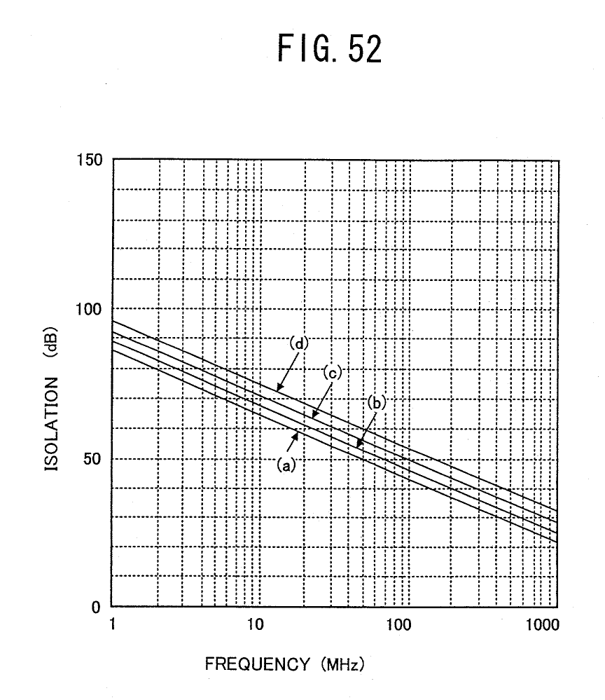

Next, FIG. 52 shows results of measurements of isolation characteristics of the conventional relays and the relays according to the present invention.

The measurements are carried out under condition that transmission impedance of each of the relay is 50Ω.

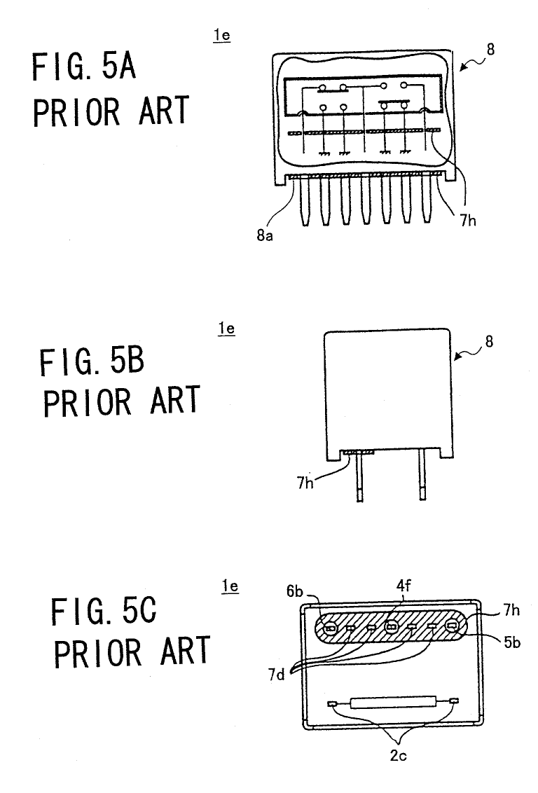

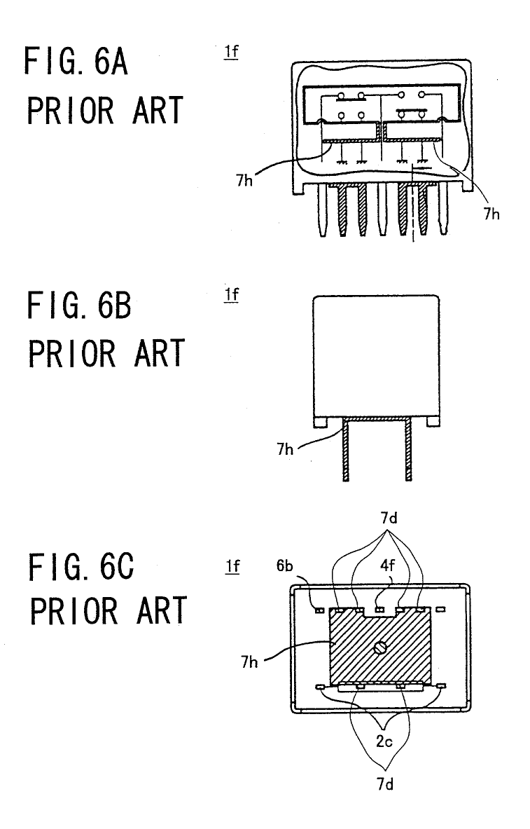

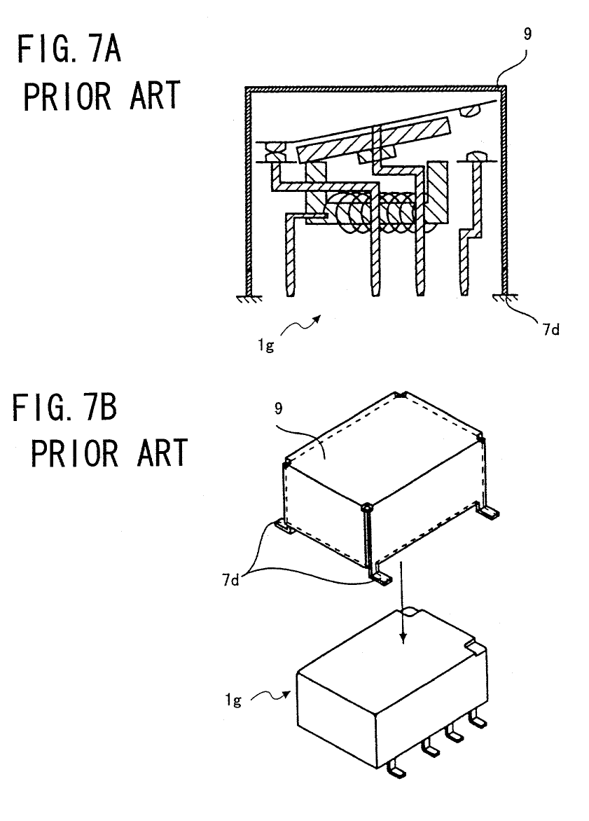

In FIG. 52, line (a) represents a measurement result with respect to the conventional relay which is bare without any metal-plate cover and the like as shown in FIG. 1A and FIG. 1B, or the relay covered only with the resinous cover as shown in FIG. 5A to FIG. 5C; line (b) represents a measurement result with respect to the conventional relay covered with the metal case at the top and the sides as shown in FIG. 7A and FIG. 7B; line (c) represents a measurement result with respect to the relay according to the first embodiment of the present invention with the box-shaped base covering the body of the relay as shown in FIG. 8A to FIG. 8C; and line (d) represents a measurement result with respect to the relay according to the fourth embodiment of the present invention with the base and the cover covering the body of the relay completely as shown in FIG. 27A and FIG. 27B. The advantages of the present invention are evident in FIG. 25.

Although the heretofore-described embodiments of the present invention set forth the conventional relay 1a as the body of the relay, the body of the relay is not limited thereto as long as the advantages of the present invention are secured. Additionally, the elements described in each of the embodiments are applicable to the corresponding elements in other embodiments as long as the advantages of the present invention are not hindered.

That is, the present invention is not limited to the specifically disclosed embodiments, and variations and modifications may be made without departing from the scope of the present invention.

The present application is based on Japanese priority application No. 2001-328209 filed on Oct. 25, 2001, the entire contents of which are hereby incorporated by reference.

What is claimed is:

1. A high-frequency relay comprising:
a body containing a contact unit connected with at least one contact terminal protruded from a bottom surface of said body, the contact unit having contact states switched according as an energization to a coil; and
a base covering at least said bottom surface, the base having a grounding function and including a conductive layer.

2. The high-frequency relay as claimed in claim 1, wherein said base is formed in a box shape covering said bottom surface and four side surfaces of said body, the box shape having an upward opening.

3. The high-frequency relay as claimed in claim 2, further comprising an openable and closable lid member capable of being closed on said upward opening, the lid member including a conductive layer so as to be electrically connected with said base.

4. The high-frequency relay as claimed in claim 1, further comprising a cover capable of covering surfaces of said body except said bottom surface, the cover including a conductive layer so as to be electrically connected with said base.

5. A high-frequency relay comprising:
a body containing a contact unit connected with at least one contact terminal protruded from a bottom surface of said body, the contact unit having contact states switched according as an energization to a coil;
a cover capable of covering surfaces of said body except said bottom surface, the cover having a grounding function and including a conductive layer; and
a base covering at least said bottom surface, the base including a conductive layer so as to be electrically connected with said cover.

6. The high-frequency relay as claimed in claim 1, wherein said base includes a ground terminal having said grounding function.

7. The high-frequency relay as claimed in claim 5, wherein said cover includes a ground terminal having said grounding function.

8. The high-frequency relay as claimed in claim 1, wherein said base includes a mounting pad so as to be mounted on a substrate, the mounting pad having said grounding function.

9. The high-frequency relay as claimed in claim 1, wherein said base is composed of a resinous molding coated with said conductive layer.

10. The high-frequency relay as claimed in claim 5, wherein said base is composed of a resinous molding coated with said conductive layer.

11. The high-frequency relay as claimed in claim 1, wherein said base includes at least one insertion hole accommodating said contact terminal inserted therethrough.

12. The high-frequency relay as claimed in claim 5, wherein said base includes at least one insertion hole accommodating said contact terminal inserted therethrough.

13. The high-frequency relay as claimed in claim 4, wherein said base is formed from a metal plate by bending so as to comprise a ground terminal bent from a bottom surface of said base and a defective part formed in said bottom surface of said base by bending said ground terminal;
said cover is formed from a metal plate by bending so as to comprise a foldable projection capable of being folded with respect to said cover; and
said defective part is closed by said foldable projection.

14. The high-frequency relay as claimed in claim 4, wherein said cover is composed of a resinous molding coated with said conductive layer.

15. The high-frequency relay as claimed in claim 5, wherein said cover is composed of a resinous molding coated with said conductive layer.

16. The high-frequency relay as claimed in claim 4, wherein said cover and said base comprise respective engaging members so that said cover and said base are engaged by said engaging members so as to be unified.

17. The high-frequency relay as claimed in claim 5, wherein said cover and said base comprise respective engaging members so that said cover and said base are engaged by said engaging members so as to be unified.

18. The high-frequency relay as claimed in claim 4, wherein one of said cover and said base is inserted into the other so as to be unified.

19. The high-frequency relay as claimed in claim 5, wherein one of said cover and said base is inserted into the other so as to be unified.

20. The high-frequency relay as claimed in claim 4, wherein said cover and said base are bonded to each other so as to be unified.

21. The high-frequency relay as claimed in claim 5, wherein said cover and said base are bonded to each other so as to be unified.

22. A high-frequency relay comprising:
a body containing a contact unit connected with a contact terminal and a ground terminal protruded from a bottom surface of said body, the contact unit having contact states switched according as an energization to a coil;
a base covering at least said bottom surface, the base including a conductive layer so as to be electrically connected with said ground terminal; and
a cover capable of covering surfaces of said body except said bottom surface, the cover including a conductive layer so as to be electrically connected with said base.

23. A high-frequency relay comprising:
a body containing a contact unit connected with at least one contact terminal protruded from a bottom surface of said body, the contact unit having contact states switched according as an energization to a coil;
a base covering at least said bottom surface, the base including a conductive layer;
a cover capable of covering surfaces of said body except said bottom surface, the cover including a conductive layer;
a ground terminal formed on one of said base and said cover; and
a standoff portion provided on one of said base and said cover.
